(19) United States
(12) Patent Application Publication
(10) Pub. No.: US 2017/0272912 A1
(43) Pub. Date: Sep. 21, 2017

(54) PROGRAM SHARING METHOD AND ELECTRONIC DEVICE

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Ruotao WANG, Beijing (CN)

(21) Appl. No.: 15/246,800

(22) Filed: Aug. 25, 2016

Related U.S. Application Data
(63) Continuation of application No. PCT/CN2016/089342, filed on Jul. 8, 2016.

(30) Foreign Application Priority Data
Mar. 21, 2016 (CN) 201610162810.6

(51) Int. Cl. H04W 4/02; H04L 29/06; H04W 76/02

(52) U.S. Cl. CPC H04W 4/027; H04W 76/02; H04L 67/42; H04W 4/028

(57) ABSTRACT

A program sharing method is disclosed. The method includes: receiving position information and program information for sharing that are uploaded by a first user; determining a site type of a site where the first user is located according to the position information; searching, within a preset range around the first user, for at least one target site of the same site type as the site where the first user is located; and generating program recommendation information according to the program information and sending the program recommendation information to at least one second user in the target site.

### CROSS-REFERENCE TO RELATED APPLICATIONS

This application is a continuation of International Application No. PCT/CN2016/089342, with an international filing date of Jul. 8, 2016, which is based upon and claims priority to Chinese Patent Application No. 201610162810.6, filed on Mar. 21, 2016, the entire contents of all of which are incorporated herein by reference.

### TECHNICAL FIELD

The present disclosure relates to the field of multimedia information recommendation technologies, and particularly, to a program sharing method and electronic device.

### BACKGROUND

Program recommendation methods used in video program systems currently available operate mainly by analyzing history viewing records of a user and recommending programs of the same type to user. However, it is not necessarily that the user always enjoys the same type of programs, and the user's need for watching programs is often associated with the site where the user is currently located, the atmosphere of the site and so on.

### SUMMARY

An embodiment of the present disclosure provides a program sharing method. The method includes:

at an electronic device;

receiving position information and program information for sharing that are uploaded by a first user;

determining a site type of a site where the first user is located according to the position information;

searching, within a preset range around the first user, for at least one target site of the same site type as the site where the first user is located; and

generating program recommendation information according to the program information and sending the program recommendation information to at least one second user in the target site.

Another embodiment of the present disclosure provides a program sharing device, the device includes: electronic device. The electronic device includes:

at least one processor; and

a memory communicably connected with the at least one processor for storing instructions executable by the at least one processor, wherein execution of the instructions by the at least one processor causes the at least one processor to:

receive position information and program information for sharing that are uploaded by a first user;

determine a site type of a site where the first user is located according to the position information;

search, within a preset range around the first user, for at least one target site of the same site type as the site where the first user is located; and

generate program recommendation information according to the program information and send the program recommendation information to at least one second user in the target site.

Still another embodiment of the present disclosure provides a non-transitory computer-readable storage medium. The non-transitory computer-readable storage medium stores executable instructions, wherein when the executable instructions are executed by an electronic device, causes the electronic device to:

receive position information and program information for sharing that are uploaded by a first user;

determine a site type of a site where the first user is located according to the position information;

search, within a preset range around the first user, for at least one target site of the same site type as the site where the first user is located; and

generate program recommendation information according to the program information and send the program recommendation information to at least one second user in the target site.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart diagram of a program sharing method according to an embodiment of the present disclosure;

FIG. 2 is a flowchart diagram of a program sharing method according to another embodiment of the present disclosure; and

FIG. 3 is a schematic structural view of a program sharing apparatus according to an embodiment of the present disclosure.

FIG. 4 is a schematic structural view of a program sharing apparatus according to another embodiment of the present disclosure.

### DETAILED DESCRIPTION

To make the objectives, technical solutions and advantages of the present disclosure clearer, a detailed description will be further made on embodiments of the present disclosure with reference to the attach drawings.

It shall be appreciated that, all references to the terms “first” and “second” in the embodiments of the present disclosure are intended to distinguish two referents having the same designations but being of different entities or having different parameters, so the terms “first” and “second” are only used for convenience of description but shall not be understood to limit the embodiments of the present disclosure. This will not be described again herein below in the following embodiments.

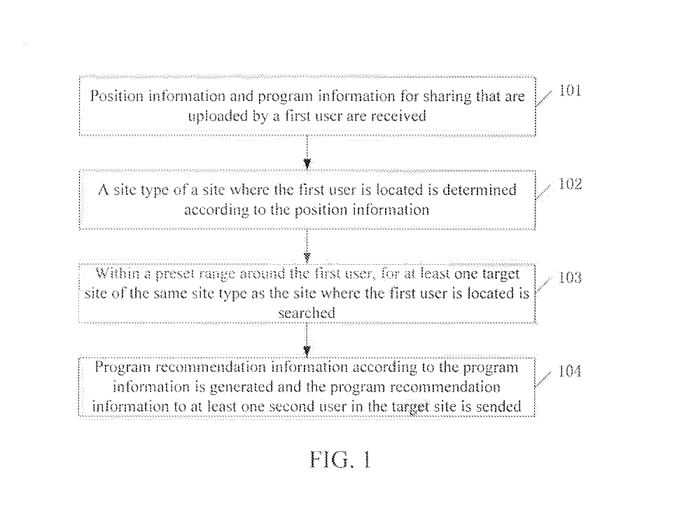

An embodiment of the present disclosure provides a program sharing method. Referring to FIG. 1, there is shown a flowchart diagram of the program sharing method according to the embodiment of the present disclosure.

The program sharing method includes the following steps:

In step 101, position information and program information for sharing that are uploaded by a first user are received.

The first user is a user that desires to share a program with others. Currently the first user is located in a certain site and watching a program that matches the environment of the current site, for example, is watching a reading-related program in a library or is watching a live show of a sports event in a bar. The first user desires to share the program that he or she is watching with other users located in the same type of sites and uploads related information that he or she desires to share. In this step, the received information uploaded by the first user includes the position information and the program information. The position information is used to determine a position of the first user and further determine a site where the first user is located in a subsequent step; and the program information is used to label the program that the first user desires to share.

In some embodiments, the program information preferably corresponds to the program that the first user is watching; and depending on different needs in use, the program information may also be a program that has been watched by the first user before.

In step 102, a site type of a site where the first user is located is determined according to the position information.

The site where the first user is currently located and information related to the type of the site are extracted from the received position information of the first user. Based on the powerful positioning technologies currently available, the common positioning services are already able to provide position information that is accurate to the precise site, e.g., “XX Coffee House located at No. XX of the XX Street”. The type of the site where the user is located can be obtained simply through extraction from this precise position information. The site type generally refers to a sort of sites that provides the same type of services, e.g., libraries, restaurants, coffee houses, bars, shopping malls, and etc.

In case where the position information contains no information about the site and the site type, the site type may be inputted and uploaded by the user. Correspondingly, in the step 101, the information about the site type uploaded by the first user is also received; and in the step 102, the site type of the site where the first user is located is determined according to the information about the site type. For example, the first user directly uploads the information that he or she is being located in a “coffee house”, and in the step 102, it is directly determined that the site type of the site where the first user is located is “coffee house”.

In step 103, within a preset range around the first user, for at least one target site of the same site type as the site where the first user is located is searched.

By searching within a preset distance range according to the aforesaid position information and based on the current position of the first user, sites of the same site type as the site where the first user is located are found. For example, all coffee houses within a distance range of 3 km from the first user (preferably including the coffee house where the first user is located) are found through searching as the target sites.

In step 104, program recommendation information according to the program information is generated and the program recommendation information to at least one second user in the target site is sent.

In this step, all users located in the target sites are found as the sharing targets (i.e., the at least one second user) through searching from the target sites determined in the previous step. The program recommendation information for sending to the sharing targets is generated according to the program information uploaded by the first user, and is sent to the at least one second user. The program recommendation information that “someone present nearby desires to share <XXX> with you”. Preferably, the position information of the first user may also be used in generation of the program recommendation information so that the exact position of the first user is shown in the program recommendation information. For example, the program recommendation information is “A user present nearby in the XX coffee house desires to share <XXX> with you”.

As can be seen from the above description, the program sharing method according to the embodiment of the present disclosure determines the position of a user and the site where the user is located and shares the program that the user desires to share with other user terminal located in nearby sites of the same site type. The embodiment of the present disclosure allows the user to recommend to and share with users located in the same type of sites a program suitable for watching in the current site environment, so the pertinency of the program recommendation is improved.

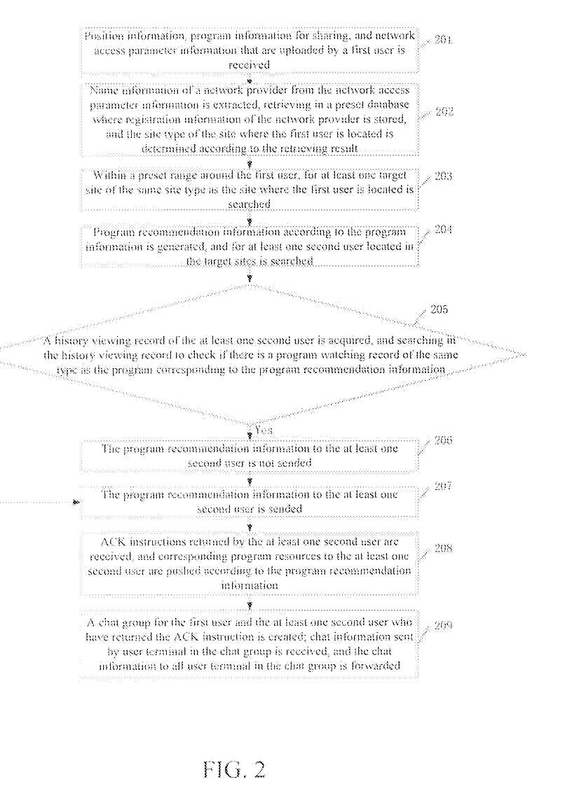

Referring to FIG. 2, there is shown a flowchart diagram of a program sharing method according to another embodiment of the present disclosure.

As a more specific embodiment, the program sharing method includes the following steps:

In step 201, position information, program information for sharing, and network access parameter information that are uploaded by a first user is received.

In this step, the first user accesses the Internet in the site where he or she is located via a network access service provided in the site, and when the first user desires to share a program, the network access parameter information is uploaded together. The network access parameters generally include the wifi name and the ip address.

In step 202, name information of a network provider from the network access parameter information is extracted, retrieving in a preset database where registration information of the network provider is stored, and the site type of the site where the first user is located is determined according to the retrieving result.

When the site type of the site where the first user is located cannot be directly obtained from the received position information of the first user, the site type is determined according to the network access parameter information. Specifically, keywords are extracted from the network access parameter information to obtain the name information of the network provider. Taking wifi accessing as an example, generally the wifi name is just the name of the network provider, e.g., the name of wifi provided by the XX coffee house is named as “XX Coffee House”. Retrieval is made in the preset database according to the extracted name information of the network provider, where the database is a database of the network side where registration information of network providers is stored (e.g., an industrial and commercial registration database). By retrieving in the database according to the name information of the network provider, related registration information of the network provider can be found. Because the registration information generally includes a service type of the business site, the site type of the site where the first user is located can be determined.

Determining the site type according to the network access parameter information avoids scenarios where the site type cannot be obtained from the position information of the first user, and allows for obtaining the site type of the site where the first user is located more conveniently, accurately and quickly.

In step 203, within a preset range around the first user, for at least one target site of the same site type as the site where the first user is located is searched.

In step 204, program recommendation information according to the program information is generated, and for at least one second user located in the target sites is searched.

In step 205, a history viewing record of the at least one second user is acquired, and searching in the history viewing record to check if there is a program watching record of the same type as the program corresponding to the program recommendation information, wherein if there is a program watching record of the same type as the program corresponding to the program recommendation information, the step 207 is proceeded, and otherwise, the step 206 is proceeded.

In step 206, the program recommendation information to the at least one second user is not sent.

In step 207, the program recommendation information to the at least one second user is sent.

For example, if the first user is now watching a live show of a sports event in a bar and shares the live show of the sports event, program recommendation information corresponding to this live show of the sports event is generated through the aforesaid steps; and after a plurality of second users in other nearby bars around the first user are found, history viewing records of the second users are acquired to check if there is any watching record of live show of sports events in the history viewing records of the second users. If there is any watching record of live show of sports events in the history viewing records of the second users, the program recommendation information is sent to the second user, and if there is no watching record of live show of sports events in the history viewing records of the second users, the program recommendation information is not sent to the second user.

Through the steps 205 to 207, screening of the at least one second user is accomplished by further considering the history viewing records of the at least one user to check if each of the at least one second user has once watched a program of the same type as the program being currently shared. Only to those of the at least one second user who have once watched a program of the same type will the program recommendation information be sent. This prevents users from receiving program recommendations in which they are not interested, thus making pushing of the program to the users more pertinent.

In step 208. ACK instructions returned by the at least one second user are received, and corresponding program resources to the at least one second user are pushed according to the program recommendation information.

In this step, the at least one user returns an ACK instruction if he or she is interested in the program corresponding to the program recommendation information. Program resources of the program corresponding to the program recommendation information are pushed to the second user in response to the received ACK instruction returned by the second user so that the at least one second user plays the corresponding program on his or her terminal.

In step 209, a chat group for the first user and the at least one second user who have returned the ACK instruction is created; chat information sent by user terminal in the chat group is received, and the chat information to all user terminal in the chat group is forwarded.

In this step, those of the at least one second user who have returned the ACK instruction have already begun to watch the program corresponding to the program recommendation information; i.e., the first user as the sharing party and the at least one second users who have accepted the sharing are all watching the same program. To facilitate communications and interactions there between, a chat group is created for them. Chat information sent by user terminal in the chat group is received and forwarded to all user terminal in the chart group. The forwarding may be accomplished by displaying the chat information to users via the chat boxes, comment messages or pop-up screens. Creation of the chat group facilitates communications among the users watching the same program and improves the interactivity.

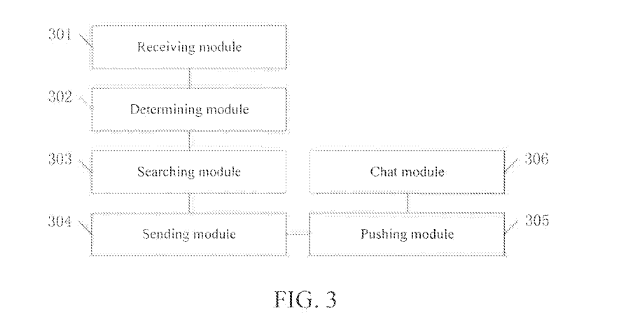

In another aspect, a program sharing apparatus is also provided in an embodiment of the present disclosure. Referring to FIG. 3, there is shown a schematic structural view of the program sharing apparatus according to an embodiment of the present disclosure.

The program sharing apparatus includes:

a receiving module 301, configured to receive position information and program information for sharing that are uploaded by a first user;

a determining module 302, configured to determine a site type of a site where the first user is located according to the position information;

a searching module 303, configured to search, within a preset range around the first user, for at least one target site of the same site type as the site where the first user is located; and

a sending module 304, configured to generate program recommendation information according to the program information and send the program recommendation information to at least one second user in the target site.

In some embodiments, the receiving module 301 is further configured to: receive site type information uploaded by the first user; and the determining module 302 is further configured to: determine the site type of the site where the first user is located according to the site type information uploaded by the first user.

In some embodiments, the receiving module 301 is further configured to: receive network access parameter information uploaded by the first user; and the determining module 302 is further configured to: extract name information of a network provider from the network access parameter information, retrieve in a preset database where registration information of the network provider is stored, and determine the site type of the site where the first user is located according to the retrieving result.

In some embodiments, the apparatus further includes a pushing module 305, which is configured to receive ACK instructions returned by the at least one second user, and push corresponding program resources to the at least one second user according to the program recommendation information.

In some embodiments, the apparatus further includes a chat module 306, which is configured to: create a chat group for the first user and the at least one second user who have returned the ACK instruction; receive chat information sent by user terminal in the chat group, and forward the chat information to all user terminal in the chat group.

In some embodiments, the sending module 304 is further configured to: acquire a history viewing record of the at least one second user, and search in the history viewing record to check if there is a program watching record of the same type as the program corresponding to the program recommendation information, wherein if there is a program watching record of the same type as the program corresponding to the program recommendation information, the program recommendation information is sent to the at least one second user, and otherwise, the program recommendation information is not sent to the at least one second user.

The program sharing apparatus of the above embodiment is used to implement the corresponding program sharing method of the previous embodiment and has the same benefits as the corresponding method embodiment, so it will not be further described herein.

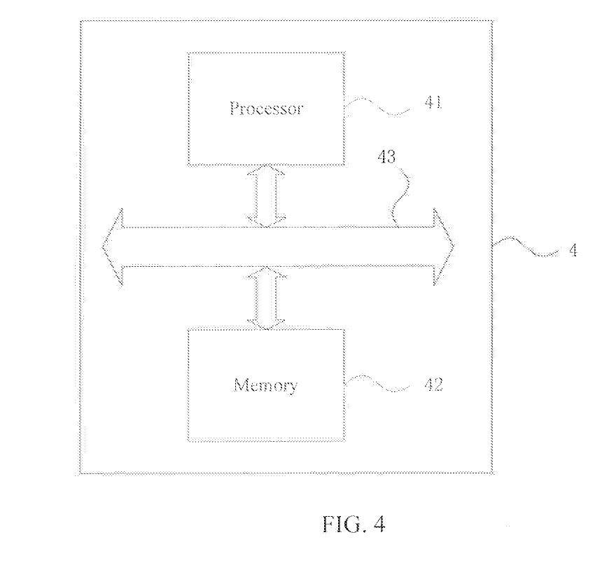

As shown in FIG. 4, FIG. 4 is an embodiment of a program sharing apparatus 40. The program sharing apparatus 40 includes: a processor 41, a memory 42, and a bus system 43. The processor 41 and the memory 42 are connected to each other via the bus system 43. The memory 42 is configured to store program instructions, and the processor 41 is configured to execute the program instructions stored in the memory 42, and the processor 41 is configured to:

receive position information and program information for sharing that are uploaded by a first user;

determine a site type of a site where the first user is located according to the position information;

search, within a preset range around the first user, for at least one target site of the same site type as the site where the first user is located; and

generate program recommendation information according to the program information and send the program recommendation information to at least one second user in the target site.

The memory 42 may be a non-transitory computed readable storage medium, which is configured to store computed executable program instructions. When the program instructions are executed by one or more central processors, for example, the processor 41 may be caused to perform the steps in the above mentioned embodiments of the method, for example, steps 101 to 103 illustrated in FIG. 1, steps 201 to 209 illustrated in FIG. 2. Or, the processor 41 may be caused to perform the modules in the above mentioned embodiments of the apparatus, for example, modules 301 to 306 illustrated in FIG. 3. The computed executable program instructions may also be stored and/or transmitted in any non-transitory computed readable storage medium, such that these program instructions are used by an instruction executing system, apparatus or device, or used in combination with the instruction executing system, apparatus or device. The instruction executing system, apparatus or device may be, for example, a computer-based system, a system including a processor or another system capable of acquiring program instructions from the instruction executing system, apparatus or device and executing the program instructions. For the purpose of this specification, the “non-transitory computed readable storage medium” may be any tangible medium including or storing computed executable program instructions. The computed executable program instructions may be used by the instruction executing system, apparatus or device, or used in combination with the executing system, apparatus or device. The non-transitory computed readable storage medium may include, but not limited to, a magnetic, optical and/or semiconductor memory. Examples of these memories include a magnetic disk, an optical disc based on CD, DVD and Blu-ray technology, and permanent solid memory (for example, a flash memory, a solid driver and the like).

It should be understood that in the embodiments of the present application, the processor 41 may be a central processing unit (CPU). The processor 41 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 43 may further includes a power bus, a control bus, a state signal bus and the like. However, for clarity of description, various buses are all marked as the bus system 43.

In the embodiments of the present disclosure, the program sharing apparatus 40 is not limited to the components and configurations as illustrated in FIG. 4, but may further includes other or additional components having a plurality of configurations.

During the implementation, various steps in the above method and various modules or units in the above apparatus may be implemented by means of an integrated logic circuit in the processor 41 or by means of software. The steps in the method and modules or the units in the apparatus disclosed in the embodiments of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 42. The processor 41 reads the information stored in the memory 42 and performs the steps of the above method in combination with the hardware thereof. For brevity of description, the details are not given herein any further.

As can be seen from the above description, the program sharing method and apparatus provided in embodiments of the present disclosure determine the position of a user and the site where the user is located and share the program that the user desires to share with other user terminal located in nearby sites of the same site type. The embodiments of the present disclosure allow the user to recommend to and share with users located in the same type of sites a program suitable for watching in the current site environment, so the pertinency of the program recommendation is improved.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity.

Additionally, for simplicity of the description and discussion and to prevent that the present disclosure is difficult to understand, publicly known power supply connections/ground connections with integrated circuits (ICs) and other parts may be or may not be shown in the attached drawings. Furthermore, the apparatus may be shown in the form of a block diagram to prevent that the present disclosure is difficult to understand and out of consideration of the following facts: details of implementations of the blocks are highly dependent on the platform on which the present disclosure is to be embodied (i.e., the details shall be completely within the scope understandable by those skilled in the art). While specific details (e.g., circuits) have been described to illustrate embodiments of the present disclosure, it shall be apparent to those skilled in the art that, the present disclosure may be embodied without these specific details or with variations of the specific details. Therefore, the description shall be considered to be illustrative rather than in a limiting sense.

Although the present disclosure has been described with reference to embodiments thereof, many replacements, modifications and variants of these embodiments will be apparent to those of ordinary skill in the art upon reviewing the above description. For example, other memory architectures (e.g., dynamic RAM (DRAM) may also utilize the discussed embodiments.

Embodiments of the present disclosure are intended to cover all such replacements, modifications and variations falling within the broad scope of the attached claims. Accordingly, any omissions, modifications, equivalent replacements, and alterations within the spirits and principles of the present disclosure shall be included in the scope of the present disclosure.

What is claimed is:

1. A program sharing method, comprising:
at an electronic device;
receiving position information and program information for sharing that are uploaded by a first user;
determining a site type of a site where the first user is located according to the position information;
searching, within a preset range around the first user, for at least one target site of the same site type as the site where the first user is located;
generating program recommendation information according to the program information; and
sending the program recommendation information to at least one second user in the target site.

2. The method according to claim 1, wherein the step of receiving position information and program information for sharing that are uploaded by a first user comprises:
receiving site type information uploaded by the first user;
the step of determining a site type of a site where the first user is located comprises:
determining the site type of the site where the first user is located according to the site type information uploaded by the first user.

3. The method according to claim 1, wherein the step of receiving position information and program information for sharing that are uploaded by a first user comprises:
receiving network access parameter information uploaded by the first user;
the step of determining a site type of a site where the first user is located comprises:
extracting name information of a network provider from the network access parameter information;
retrieving in a preset database where registration information of the network provider is stored; and
determining the site type of the site where the first user is located according to the retrieving result.

4. The method according to claim 1, wherein after the step of sending the program recommendation information to the at least one second user in the target site, the method further comprises:
receiving ACK instructions returned by the at least one second user; and
pushing corresponding program resources to the at least one second user according to the program recommendation information.

5. The method according to claim 4, wherein after the step of pushing the corresponding program resources to the at least one second user, the method further comprises:
creating a chat group for the first user and the at least one second user who have returned the ACK instruction;
receiving chat information sent by user terminal in the chat group; and
forwarding the chat information to all user terminal in the chat group.

6. The method according to claim 1, wherein the step of sending the program recommendation information to at least one second user in the target site comprises:
acquiring a history viewing record of the at least one second user; and
searching in the history viewing record to check if there is a program watching record of the same type as the program corresponding to the program recommendation information, wherein if there is a program watching record of the same type as the program corresponding to the program recommendation information, the program recommendation information is sent to the at least one second user, and otherwise, the program recommendation information is not sent to the at least one second user.

7. An electronic device, comprising:
at least one processor; and
a memory communicably connected with the at least one processor for storing instructions executable by the at least one processor, wherein execution of the instructions by the at least one processor causes the at least one processor to:
receive position information and program information for sharing that are uploaded by a first user;
determine a site type of a site where the first user is located according to the position information;
search, within a preset range around the first user, for at least one target site of the same site type as the site where the first user is located;
generate program recommendation information according to the program information; and
send the program recommendation information to at least one second user in the target site.

8. The electronic device according to claim 7, wherein the step to receive position information and program information for sharing that are uploaded by a first user comprises:
receiving site type information uploaded by the first user;
determining a site type of a site where the first user is located comprises:
determining the site type of the site where the first user is located according to the site type information uploaded by the first user.

9. The electronic device according to claim 7, wherein the step to receive position information and program information for sharing that are uploaded by a first user comprises:
receiving network access parameter information uploaded by the first user;
determining a site type of a site where the first user is located comprises:
extracting name information of a network provider from the network access parameter information;
retrieving in a preset database where registration information of the network provider is stored; and
determining the site type of the site where the first user is located according to the retrieving result.

10. The electronic device according to claim 7, wherein after sending the program recommendation information to the at least one second user in the target site, execution of the instructions by the at least one processor causes the at least one processor to:
receive ACK instructions returned by the at least one second user; and
push corresponding program resources to the at least one second user according to the program recommendation information.

11. The electronic device according to claim 10, wherein after pushing the corresponding program resources to the at least one second user, execution of the instructions by the at least one processor causes the at least one processor to:
create a chat group for the first user and the at least one second user who have returned the ACK instruction;
receive chat information sent by user terminal in the chat group; and
forward the chat information to all user terminal in the chat group.

12. The electronic device according to claim 7, wherein the step to send the program recommendation information to at least one second user in the target site comprises:
acquiring a history viewing record of the at least one second user; and
searching in the history viewing record to check if there is a program watching record of the same type as the program corresponding to the program recommendation information, wherein if there is a program watching record of the same type as the program corresponding to the program recommendation information, the program recommendation information is sent to the at least one second user, and otherwise, the program recommendation information is not sent to the at least one second user.

13. A non-transitory computer-readable storage medium storing executable instructions, wherein when executed by an electronic device, causes the electronic device to:
receive position information and program information for sharing that are uploaded by a first user;
determine a site type of a site where the first user is located according to the position information;
search, within a preset range around the first user, for at least one target site of the same site type as the site where the first user is located;
generate program recommendation information according to the program information; and
send the program recommendation information to at least one second user in the target site.

14. The non-transitory computer-readable storage medium according to claim 13, wherein the step to receive position information and program information for sharing that are uploaded by a first user comprises:
receiving site type information uploaded by the first user;
determining a site type of a site where the first user is located comprises:
determining the site type of the site where the first user is located according to the site type information uploaded by the first user.

15. The non-transitory computer-readable storage medium according to claim 13, wherein the step to receive position information and program information for sharing that are uploaded by a first user comprises:
receiving network access parameter information uploaded by the first user;
determining a site type of a site where the first user is located comprises:
extracting name information of a network provider from the network access parameter information;
retrieving in a preset database where registration information of the network provider is stored; and
determining the site type of the site where the first user is located according to the retrieving result.

16. The non-transitory computer-readable storage medium according to claim 13, wherein after sending the program recommendation information to the at least one second user in the target site, when the executable instructions is executed by the electronic device, causes the electronic device to:
receive ACK instructions returned by the at least one second user; and
push corresponding program resources to the at least one second user according to the program recommendation information.

17. The non-transitory computer-readable storage medium according to claim 16, wherein after pushing the corresponding program resources to the at least one second user, when the executable instructions is executed by the electronic device, causes the electronic device to:
create a chat group for the first user and the at least one second user who have returned the ACK instruction;
receive chat information sent by user terminal in the chat group; and
forward the chat information to all user terminal in the chat group.

18. The non-transitory computer-readable storage medium according to claim 13, wherein sending the program recommendation information to at least one second user in the target site comprises:
acquiring a history viewing record of the at least one second user; and
searching in the history viewing record to check if there is a program watching record of the same type as the program corresponding to the program recommendation information, wherein if there is a program watching record of the same type as the program corresponding to the program recommendation information, the program recommendation information is sent to the at least one second user, and otherwise, the program recommendation information is not sent to the at least one second user.
